(19) United States
(12) Patent Application Publication
(10) Pub. No.: US 2009/0071758 A1
(43) Pub. Date: Mar. 19, 2009

(54) ELEVATOR

(75) Inventors: Zhigang YU, Shenyang (CN); Yunsong GU, Shenyang (CN); Hetong MAO, Shenyang (CN); Hongwen LI, Shenyang (CN); Junbin LI, Shenyang (CN)

Correspondence Address: MATTHIAS SCHOLL, 14781 MEMORIAL DRIVE, SUITE 1319, HOUSTON, TX, 77079, US

(73) Assignee: SHENYANG BRILLIANT ELEVATOR CO., LTD., Shenyang (CN)

(21) Appl. No.: 12/272,852

(22) Filed: Nov. 18, 2008

Related U.S. Application Data
(63) Continuation of application No. PCT/CN2006/001246, filed on Jun. 8, 2006.

(30) Foreign Application Priority Data
May 19, 2006 (CN) 200610081438.2

(51) Int. Cl. B66B 11/08

(52) U.S. Cl. 187/254; 187/250

(57) ABSTRACT

Provided is an elevator car frame, comprising: an elevator cage, a main elevator car frame comprising a pair of main columns, an upper main beam and a lower main beam, and a pair of diversion sheaves; wherein the main columns are disposed on both sides of the elevator cage; the upper main beam is disposed above the elevator cage; the lower main beam is disposed below the elevator cage; the diversion sheaves are disposed on one side of the upper main beam; and a line connecting centers of the diversion sheaves is parallel to the upper main beam. The invention features increased working space, reduced height of the elevator car roof, and lower cost.

### CROSS-REFERENCE TO RELATED APPLICATIONS

This application is a continuation of International Patent Application No. PCT/CN2006/001246, with an international filing date of Jun. 8, 2006, designating the United States, now pending, which is based on Chinese Patent Application No. 200610081438.2, filed May 19, 2006. The contents of these specifications are incorporated herein by reference.

### BACKGROUND OF THE INVENTION

1. Field of the Invention

The invention relates to the field of elevators.

2. Description of the Related Art

A conventional elevator, as shown in FIGS. 6 and 7, consists of a hoisting machine 3 disposed above an elevator hoistway, a control system, an elevator car 12 within the elevator hoistway, a counterweight 16, and a guide wheel 18. The elevator car frame is disposed outside the elevator car 12, and consists of a pair of main columns 13 disposed in the centers of a left portion and a right portion of the elevator car 13, an upper beam 8 disposed above the elevator car 12, and a lower beam disposed below the elevator car 12. A pair of guide shoes 6 each adapted to fit with a guide rail are disposed on both ends of the upper beam 8, and another pair of guide shoes 6 (not shown) each fit with a guide rail are disposed on both ends of the lower beam. A wire rope 2 passes through the guide wheel 18 and the hoisting machine 3. Both ends of the wire rope 2 are connected to the elevator car 12 and the counterweight 16, respectively.

However, problems with a conventional elevator include insufficient working space for conducting repairs between the top of an elevator car and the top of a hoistway, or conversely the necessity of a high ceiling of the elevator shaft, which wastes materials and increases costs.

### SUMMARY OF THE INVENTION

In view of the above-described problems, it is one objective of the invention to provide an elevator that features increased working space and reduced height of an elevator shaft, which saves materials and cost.

In order to achieve the above objectives, in accordance with one embodiment of the invention, provided is an elevator, comprising: an elevator cage, a main elevator car frame comprising a pair of main columns, an upper main beam, and a lower main beam, and a pair of diversion sheaves; wherein the main columns are disposed on both sides of the elevator cage; the upper main beam is disposed above the elevator cage; the lower main beam is disposed below the elevator cage; the diversion sheaves are disposed on one side of the upper main beam; and a line connecting centers of the diversion sheaves is parallel to the upper main beam.

In a class of this embodiment or in another embodiment, the diversion sheaves are disposed on the upper main beam via a diversion axis.

In a class of this embodiment or in another embodiment, the diversion axis is perpendicular to the upper main beam.

In a class of this embodiment or in another embodiment, the elevator car frame further comprises an auxiliary upper beam parallel to the upper main beam.

In a class of this embodiment or in another embodiment, the diversion sheaves are disposed between the upper main beam and the auxiliary upper beam.

In a class of this embodiment or in another embodiment, a pair of guide shoes is disposed on both ends of the upper main beam.

In a class of this embodiment or in another embodiment, there is a certain positive distance between a line connecting centers of the guide shoes and the line connecting centers of the diversion sheaves.

In a class of this embodiment or in another embodiment, the line connecting the diversion sheaves lies on the same plane as a vertical axis line of the elevator car.

In a class of this embodiment or in another embodiment, the elevator car frame further comprises an auxiliary lower beam parallel to the lower main beam.

In a class of this embodiment or in another embodiment, the elevator car frame further comprises a pair of auxiliary columns parallel to the main columns.

In a class of this embodiment or in another embodiment, upper ends of the auxiliary columns are disposed on both ends of the auxiliary upper beam.

In a class of this embodiment or in another embodiment, lower ends of the auxiliary columns are disposed on both ends of the auxiliary lower beam.

In a class of this embodiment or in another embodiment, the elevator further comprises a wire rope, an auxiliary anchor, a main anchor, a counterweight having a counterweight sheave, and a traction sheave, wherein one end of the wire rope is fixed to the auxiliary anchor; the wire rope passes through the counterweight sheave, the traction sheave, and the diversion sheaves, and the other end of the wire rope is fixed to the main anchor.

Since the diversion sheaves are disposed on one side of the upper main beam and particularly at the edge of the elevator car frame and the hoisting machine is disposed outside of a vertical projection plane of the working space at the top of the elevator car frame, the working space is increased, the height of the elevator car roof is reduced, and materials and cost are conserved.

### BRIEF DESCRIPTION OF THE DRAWINGS

Detailed description will be given below with reference to accompanying drawings.

FIG. 1 is a perspective view of an elevator according to one embodiment of the invention;

FIG. 2 is a front view of an elevator according to one embodiment of the invention;

FIG. 3 is a right side view of the elevator according to one embodiment of the invention;

FIG. 4 is a top view of an elevator according to one embodiment of the invention;

FIG. 5 illustrates a guide shoe and an elevator car according to one embodiment of the invention;

FIG. 6 is a schematic view of a conventional elevator; and

FIG. 7 is a right side view of the conventional elevator car frame shown in FIG. 6.

### DETAILED DESCRIPTION OF THE INVENTION

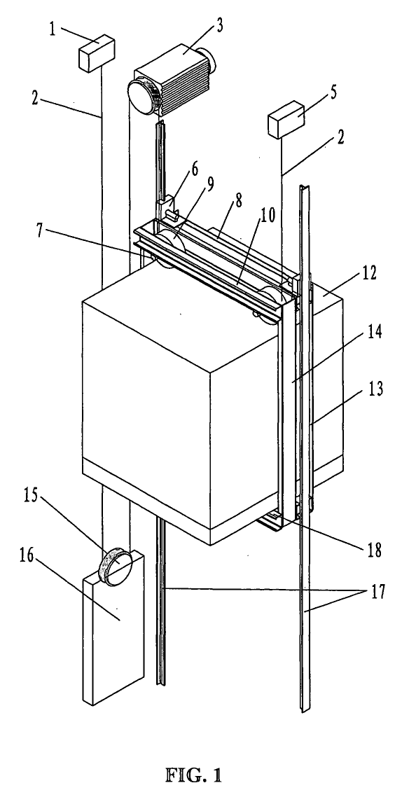

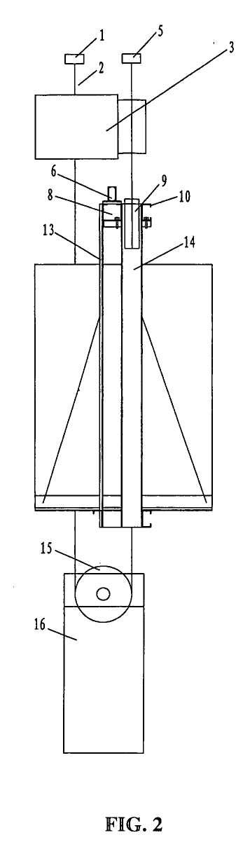

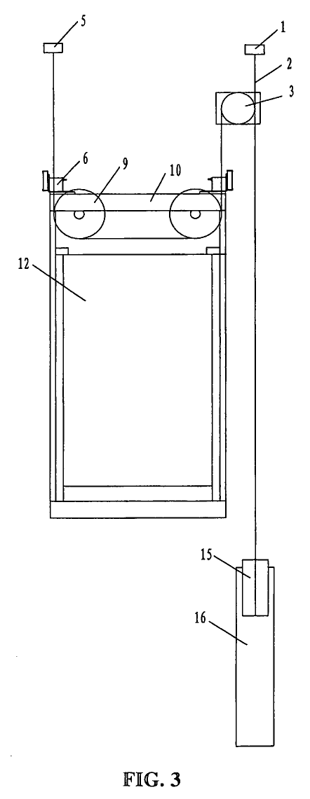

Referring to FIGS. 1, 2, 3 and 5, the elevator of the invention comprises a hoisting machine 3, a control system, an elevator car 12, a counterweight 16, an auxiliary anchor 1, a main anchor 5, and a diversion sheave 15. The hoisting machine is disposed above a hoistway. The elevator car 12 and the counterweight 16 are disposed in the hoistway. The auxiliary anchor 1 and the main anchor 5 are disposed above the hoistway. The counterweight sheave 15 is disposed on the counterweight 16.

A main elevator car frame and an auxiliary elevator car frame are disposed outside the elevator car 12. The main elevator car frame comprises: a pair of main columns 13 disposed on both sides of the elevator car 12, an upper main beam 8 disposed above the elevator car 12, and a lower main beam disposed below the elevator car 12. Upper ends of the main columns 13 are disposed on one side of the upper main beam 8, and lower ends thereof are disposed on one side of the lower main beam. A pair of guide shoes 6 is disposed on both ends of the upper main beam 8 and the lower main beam.

The auxiliary elevator car frame comprises a pair of auxiliary columns 14 disposed on both sides of the elevator car 12 and being parallel to the main columns 13, an auxiliary upper beam 10 disposed above the elevator car 12, and an auxiliary lower beam 18 disposed below the elevator car 12. Lower ends of the auxiliary columns 14 are disposed on the other side of the lower main beam, and upper ends thereof are disposed on the other side of the upper main beam 8. The auxiliary lower beam is parallel to the lower main beam. The auxiliary upper beam 10 is parallel to the upper main beam 8.

As shown in FIG. 5, the upper main beam 8 and the lower main beam are disposed between the main column 13 and the auxiliary column 14, and thus the guide shoes 6 disposed on both ends of the upper main beam 8 and the lower main beam are disposed between the main column 13 and the auxiliary column 14, and the guide rail 17 fitting with the guide shoe 6 is disposed in the vicinity of the elevator car 12 and away from the main column 13 and the auxiliary column 14. In this embodiment, the distance between the guide rails is relatively small, the cross section of the hoistway is small, and building materials are conserved accordingly.

A pair of diversion sheaves 9 is disposed between the upper main beam 8 and the auxiliary upper beam 10. A line connecting centers of the diversion sheaves 9 lies in the same plane as the vertical axis of symmetry of the elevator car 12. This design significantly reduces the eccentric load applied to the elevator car 12. The elevator is hoisted as follows: one end of the wire rope 2 is fixed to the auxiliary anchor 1; the other end thereof passes the counterweight sheave 15, the traction sheave of the hoisting machine 3 and the diversion sheaves 9, and is then fixed to the anchor 5. During operation of the elevator, the main column 13 operates to guide the elevator car 12 directionally, and the auxiliary column 14 operates to stabilize the elevator car frame as load is biased or the safety gear operates.

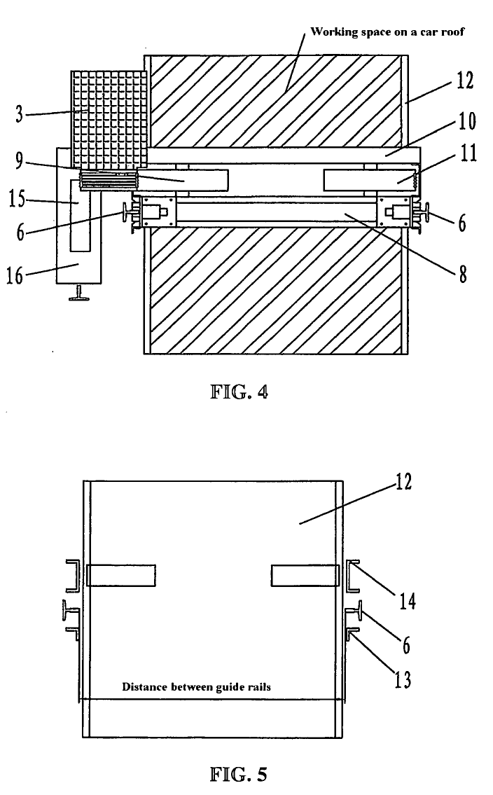

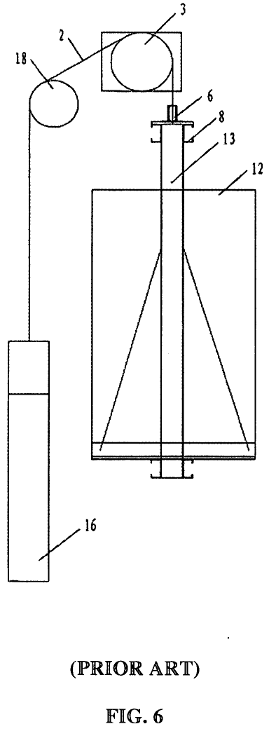

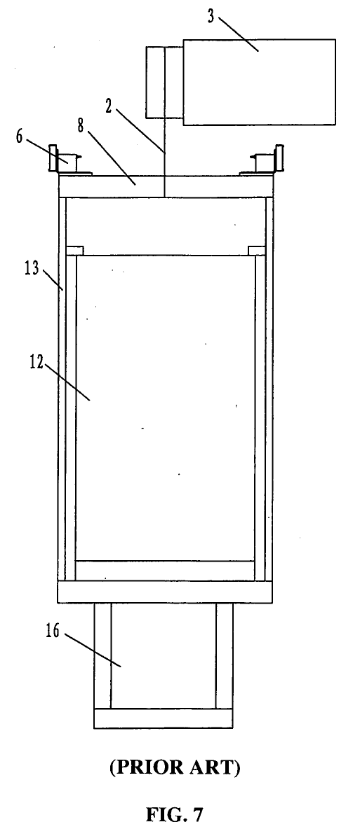

As shown in FIG. 4, the diversion sheaves 9 are disposed on the upper main beam 8 and the auxiliary upper beam 10 via a pair of diversion axes 7. The distance between one diversion sheave 9 and an edge of the elevator car 12 is the same as that between another diversion sheave 9 and the edge of the elevator car 12. The outer portion of the diversion sheave 9 outside working space is in the vicinity of the edge of the elevator car 12. The diversion axes 7 are perpendicular to the upper main beam 8 so as to ensure that the line connecting centers of the diversion sheaves 9 is parallel to the upper main beam 8. There is a certain distance therebetween, and the diversion sheave 9 is disposed in the vicinity of the edge of the elevator car 12 and away from the guide shoe 6. The line connecting centers of the diversion sheaves 9 lies in the same plane as the vertical axis of the elevator car 12, whereby significantly reducing eccentric load applied to the elevator car 12.

Since the diversion sheaves 9 are disposed between the upper main beam 8 and the auxiliary upper beam 10, this allows the diversion sheaves 9 to be disposed on the edge of the elevator car 12, the wire rope 2 between the hoisting machine 3 and one of the diversion sheaves 9 to be disposed on the edge of the elevator car 12 or at a position outside of the working space of the elevator car 12. Thus, the hoisting machine 3 is disposed outside of the working space at the top of the elevator car 12. Moreover, installation of the diversion sheaves 9 at the top of the elevator car 12 makes repairing operation convenient, improves operating stability of the elevator car 12, avoids the requirement of greater depth of the elevator pit as the diversion sheaves 9 are disposed at the bottom of the elevator car 12. Therefore, building materials are conserved.

In addition, since the hoisting machine 3 is disposed at a low position of the hoistway, and a machine room is not needed, sufficient repair space at the top of the elevator car 12 is ensured, the height of an elevator car roof is decreased, and vertical space utilization is improved. Moreover, since the distance between the guide rails 17 is reduced, a smaller hoistway can be accommodated in this design.

The elevator car frame of the invention is applicable to all elevators, and particularly those with a suspension ratio of 2:1, such as passenger elevators, goods elevators, medical elevators, observation elevators, and so on. The diversion sheaves 9 can be freely disposed on the left or right end of the upper main beam 8, and repair space is significantly increased. In addition, separate installations of the main column 13 and the auxiliary column 14 ensures high durability and small distance between guide rails 17 saves cross-section space of the hoistway. The elevator car frame is applicable to different types of hoistways.

This invention is not to be limited to the specific embodiments disclosed herein and modifications for various applications and other embodiments are intended to be included within the scope of the appended claims. While this invention has been described in connection with particular examples thereof, the true scope of the invention should not be so limited since other modifications will become apparent to the skilled practitioner upon a study of the drawings, specification, and following claims.

The invention claimed is:

1. An elevator, comprising:
an elevator cage;
a main elevator car frame comprising a pair of main columns, an upper main beam and a lower main beam; and
a pair of diversion sheaves each having a center;
wherein
said main columns are disposed on both sides of said elevator cage;
said upper main beam is disposed above said elevator cage;
said lower main beam is disposed below said elevator cage;
said diversion sheaves are disposed on one side of said upper main beam; and
a line connecting the centers of said diversion sheaves is parallel to said upper main beam.

2. The elevator of claim 1, wherein said diversion sheaves are disposed on said upper main beam via a diversion axis.

3. The elevator of claim 2, wherein said diversion axis is perpendicular to said upper main beam.

4. The elevator of claim 1, further comprising an auxiliary upper beam parallel to said upper main beam.

5. The elevator car frame of claim 4, wherein said diversion sheaves are disposed between said upper main beam and said auxiliary upper beam.

6. The elevator of claim 1, wherein a pair of guide shoes is disposed on both ends of said upper main beam.

7. The elevator of claim 6, wherein a distance separates a line connecting centers of said guide shoes and said line connecting centers of said diversion sheaves.

8. The elevator of claim 7, wherein said line connecting said diversion sheaves lies in the same plane as a vertical axis line of said elevator car.

9. The elevator of claim 1, further comprising an auxiliary lower beam, said auxiliary lower beam being parallel to said lower main beam.

10. The elevator of claim 1, further comprising a pair of auxiliary columns, said auxiliary columns being parallel to said main columns.

11. The elevator of claim 10, wherein upper ends of said auxiliary columns are disposed on both ends of said auxiliary upper beam.

12. The elevator of claim 11, wherein lower ends of said auxiliary columns are disposed on both ends of said auxiliary lower beam.

13. The elevator of claim 1, wherein said line connecting said diversion sheaves lies in the same plane as a vertical axis line of said elevator car.

14. The elevator of claim 1, further comprising a wire rope, an auxiliary anchor, a main anchor, a counterweight having a counterweight sheave, and a traction sheave, wherein one end of the wire rope is fixed to said auxiliary anchor; the wire rope passes through said counterweight sheave, said traction sheave, and said diversion sheaves, and the other end of said wire rope is fixed to said main anchor.
